(19) United States
(12) Patent Application Publication
(10) Pub. No.: US 2024/0419704 A1
(43) Pub. Date: Dec. 19, 2024

(54) ADAPTIVE TF-IDF INFERENCE ENGINE

(71) Applicant: International Business Machines Corporation, Armonk, NY (US)

(72) Inventors: Dominic Rossillo, Highland, NY (US); Michael Terrence Cohoon, Fishkill, NY (US); STEVEN LAFALCE, Salt Point, NY (US); James A. O'Connor, Ulster Park, NY (US)

(21) Appl. No.: 18/335,478

(22) Filed: Jun. 15, 2023

(51) Int. Cl. G06F 16/33

(52) U.S. Cl. CPC G06F 16/3335; G06F 16/3334

(57) ABSTRACT

In an approach, a processor preprocesses a corpus of documents of a given subject matter by: scanning each document in the corpus to identify stop words, which either is a high occurrence word that appears in at least a first pre-set threshold number of documents or a low occurrence word that appears in less than a second pre-set threshold number of documents; adding the stop words to a list of stop words; performing a spellcheck function on the corpus of documents; scanning each document in the corpus to identify subject matter relevant words based on the given subject matter; adding the identified SMR words to a list of SMR words; and assigning a weight to each identified SMR word based on a term frequency. A processor performs a similarity assessment on the corpus using the list of stop words and the list of SMR words with associated weights.

### BACKGROUND OF THE INVENTION

The present invention relates generally to the field of data processing, and more particularly to an adaptive TF-IDF inference engine for improving data searching.

Search engines utilize search terms to locate records or documents based on relevance to a query. Methods used by modern search engines to find websites most relevant to a query can be more complicated than simply text-based ranking since there may be millions of websites that contain a particular word or phrase. The relevance of a webpage is judged by looking at the number of links to it. A rank of each webpage is assigned based on the number of pages that point to it.

While the number of links approach has proven effective for finding pertinent websites, this approach does not lend itself for use in finding the most similar records or documents in a large corpus of records and documents. One approach used to identify records or documents that may be duplicates is to score each record or document by calculating the Term Frequency-Inverse Document Frequency (TF-IDF). Cosine similarity can then be used to score or weight the relevance of the documents. A final score is associated with each document, in which the higher the score a document has, the greater the similarity to the search query.

Stop words are often used to improve the accuracy and efficiency of the similarity measurement. For example, the word “the” would typically be ubiquitous in English language documents, and since it so commonly used, it provides no value in identifying similarity. Therefore, “the” would be on a list of stop words that are ignored when doing a similarity comparison. It is common practice to have words like “the”, “but”, “a”, “an”, etc. on the list of stop words as default to be ignored during similarity analysis.

### SUMMARY

Aspects of an embodiment of the present invention disclose a method, computer program product, and computer system for an adaptive TF-IDF inference engine for improving data searching. A processor preprocesses a corpus of documents of a given subject matter in preparation for performing a similarity assessment on the corpus. A processor preprocesses the corpus by: scanning each document in the corpus to identify stop words, wherein a stop word is a high occurrence word that appears in at least a first pre-set threshold number of documents in the corpus or a low occurrence word that appears in less than a second pre-set threshold number of documents in the corpus; adding the stop words to a list of stop words; performing, by the one or more processors, a spellcheck function on the corpus of documents, wherein the spellcheck function takes into consideration the given subject matter for determining whether a word is misspelled or is a unique term known in the given subject matter; scanning, by the one or more processors, each document in the corpus to identify subject matter relevant words based on the given subject matter, wherein a subject matter relevant word is a word that is not on the list of stop words and is not identified by the spellcheck function as a misspelled word; adding the identified subject matter relevant words to a list of subject matter relevant words; and assigning a weight to each identified subject matter relevant word based on a term frequency, wherein the term frequency equals how many times a word appears in a respective document divided by a total number of words in the respective document. A processor performs a similarity assessment on the corpus using the list of stop words and the list of subject matter relevant words with associated weights.

### BRIEF DESCRIPTION OF THE DRAWINGS

FIG. 1 is a functional block diagram illustrating a distributed data processing environment, for running an adaptive TF-IDF program, in accordance with an embodiment of the present invention.

FIG. 2 is a flowchart depicting operational steps of the adaptive TF-IDF program, for improving data searching using an adaptive TF-IDF inference engine, running on a computer of the distributed data processing environment of FIG. 1, in accordance with an embodiment of the present invention.

### DETAILED DESCRIPTION

Embodiments of the present invention recognize that a new and significant factor associated with improving the accuracy of similarity comparisons is encountered when the universe of possible terms goes beyond standard English language words. For example, an uncorrected misspelled word might be rare in a document, but if it is considered a relevant term during a similarity analysis, it could have a high IDF value relative to other true terms giving it unwanted importance in the similarity comparison calculation. In another example, if TF-IDF similarity analysis is being used with other non-English word terminology, such as computer systems language, a significant increase in possible terms occurs. Following this example, a term such as “=====7” or “@_568AD&” might appear relatively frequently in a program listing or a computer fault log, but just like the word “the”, these terms may be of little or no value in determining similarity. There can be hundreds and even thousands of these cryptic valueless terms that could be and should be included in a list of stop words.

Embodiments of the present invention provide an adaptive TF-IDF inference engine to identify subject matter relevant terms and stop words for improving query searching of a corpus (of documents and/or records, hereinafter collectively referred to as “documents”). Embodiments of the present invention scan each term in the corpus to identify unique prevalent terms (including non-English words or terms) that are encountered in substantially all of the documents. Terms that appear in a majority of documents are automatically added to the list of stop words that are not considered during similarity analysis. For example, the term “=====7” could be a standard delimiter in a problem log output and encountered in most documents, thus it is of no value in determining similarity and would lengthen the similarity calculation time if not included in the list of stop words and ignored.

Embodiments of the present invention also scan the corpus to identify single occurrence or low occurrence terms, such as misspelled words or low occurrence irrelevant terms. When a single occurrence or low occurrence term appears in a single document, embodiments of the present invention automatically add that term to the list of stop words. When new documents are added to the corpus, embodiments of the present invention reperform this single or low occurrence analysis to ensure the new document does not have any of the single or low occurrence terms from the list of stop words.

Additionally, for the single occurrence or low occurrence terms encountered in a single document, embodiments of the present invention perform a spellcheck function to identify terms that closely match real words, and if there is a match, embodiments of the present invention correct the misspelled word. For terms that are encountered that do not match anything in the English dictionary, embodiments of the present invention identify these terms as non-English dictionary words and automatically adds the terms to a custom dictionary. Once in the custom dictionary, these terms can be used to identify misspelled words and then those misspelled words can be corrected.

Embodiments of the present invention further scan the corpus for the remaining terms that appear in more than one document (but not substantially all of the documents) and can also be non-English dictionary terms. For these terms, embodiments of the present invention add the terms to a list of remaining words and assign a TF multiplier to each word, which will add greater weight to these terms during a similarity assessment.

Gleaning insights from vast quantities of unstructured data is a daunting challenge. Even the most basic processes aimed at identifying common words and word counts for each document and comparing these results to find intersections can require considerable computation time. Embodiments of the present invention reduces computational requirements and allows for a more effective, incremental, simplified, and automated approach for identifying subtle and complex insights, which enables extension of analytical and cognitive capabilities of computer systems.

Implementation of embodiments of the invention may take a variety of forms, and exemplary implementation details are discussed subsequently with reference to the Figures.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

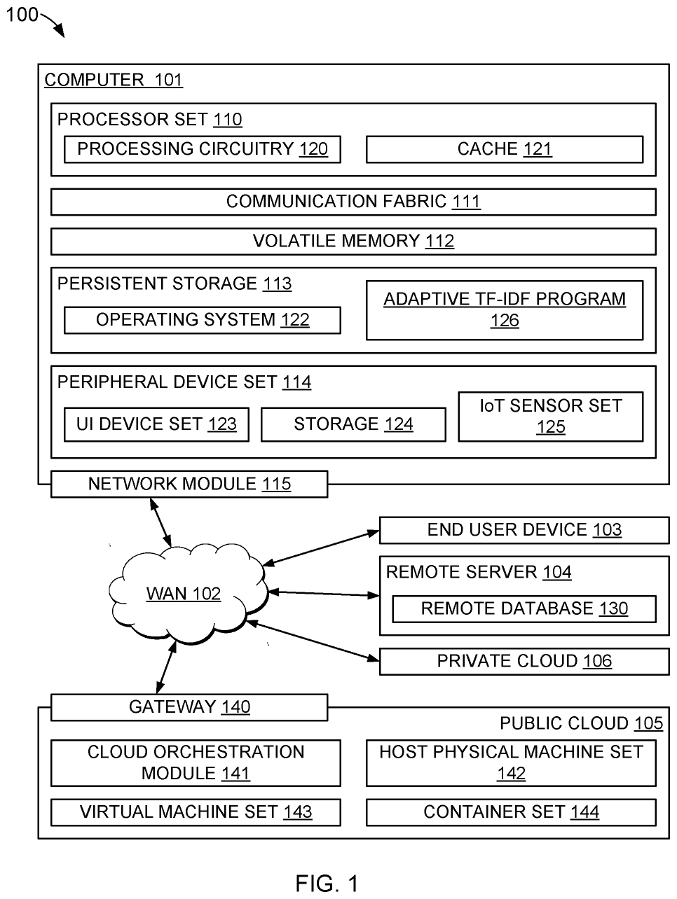

In FIG. 1, computing environment 100 contains an example of an environment for the execution of at least some of the computer code involved in performing the inventive methods, such as adaptive TF-IDF program 126. In addition to block 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processors set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 116 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

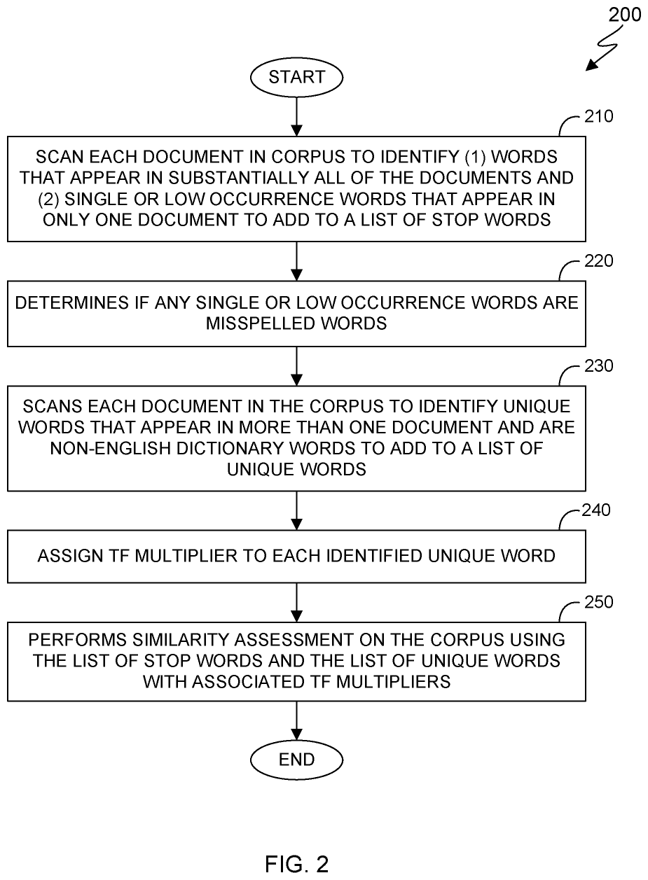

Adaptive TF-IDF program 126 operates as an adaptive TF-IDF inference engine for improving data searching by enabling optimized similarity assessments of a corpus of data through identification of (1) stop words to be ignored during similarity assessments and (2) relevant words to be weighted during similarity assessments. In other words, adaptive TF-IDF program 126 is used to prepare a corpus for a similarity assessment, and thereby improving the quality of the similarity assessment and insights that can be gleaned from the similarity assessment. A process flow of adaptive TF-IDF program 126 is depicted and described in further detail with respect to FIG. 2.

FIG. 2 is a flowchart 200 depicting operational steps of a process flow of adaptive TF-IDF program 126, for an adaptive TF-IDF inference engine for improving similarity assessments of a data corpus, running on computer 101 of computing environment 100 of FIG. 1 in accordance with an embodiment of the present invention. In an embodiment, the process flow of adaptive TF-IDF program 126 executes on a computer (e.g., computer 101 of FIG. 1), a processor (e.g., a processor of processor set 110 of FIG. 1), and/or processing circuitry (e.g., processing circuitry of processor set 110), to optimize similarity assessment of a data corpus. It should be appreciated that the process depicted in FIG. 2 illustrates one possible iteration of the process flow of adaptive TF-IDF program 126, which can be initiated upon receiving a corpus of data of a given subject matter or a request to perform a similarity assessment on a corpus of data (e.g., documents, records, etc.) of a given subject matter.

In step 210, adaptive TF-IDF program 126 scans each document in the corpus to identify words to add to a list of stop words. In an embodiment, adaptive TF-IDF program 126 scans each document for two types of words to add to the list of stop words: (1) a word that appears in substantially all of the documents, i.e., high occurrence words that appear in at least a pre-set threshold number of documents, e.g., 90% or more of the documents in the corpus, and (2) a single occurrence word or low occurrence word that appears in only a single document or substantially small number of documents, in which a low occurrence word is determined based on the word only appearing in a single document or the number of documents the word appears in is below a pre-set threshold number of documents in the corpus, e.g., less than 2% of the documents in the corpus. In an embodiment, adaptive TF-IDF program 126 creates and updates the list of stop words as words are identified that meet the criteria of (1) or (2) above.

In step 220, adaptive TF-IDF program 126 determines if any of the single occurrence or low occurrence words are misspelled words using a spellcheck function (as known to a person of skill in the art) that takes into consideration the given subject matter of the corpus. This is helpful because a word that would be classified as a misspelled word in one subject area may actually be a subject matter relevant word in another subject area due to that spelling of a non-English term being known in the other subject area. In an embodiment, adaptive TF-IDF program 126 performs a spellcheck function to identify words that closely match (i.e., within a preset threshold) or are common misspellings of a main language of words of the corpus, e.g., English dictionary words, or words that closely match (i.e., within a preset threshold) or are common misspellings of a term of a given subject area of the corpus. If there is a match or identified common misspelling, adaptive TF-IDF program 126 corrects the misspelled word. For a term that is encountered that does not closely match anything in the English dictionary and is not a common misspelling of an English dictionary word, adaptive TF-IDF program 126 determines whether the term is a common or known term of the given subject matter, i.e., a known acronym or program function name of the given subject matter. If adaptive TF-IDF program 126 determines the term is a common or known term of (i.e., within the context of) the given subject matter, then adaptive TF-IDF program 126 identifies the term as valid non-English dictionary words and automatically adds the terms to a custom dictionary. For example, some terms that could be identified include CPACF, CICS, COBOL, Db2, ICSF, IMS, RMM, CEC, CPC, IODF, PTP, FTP, SFTP, and STP, which are common acronyms in the computing area that could appear as low occurrence terms in documents in a corpus centered around computing. Additionally, program function names that are combinations of words might be identified by adaptive TF-IDF program 126, such as decryptCert and ReadFile, as terms that do not closely match any words in the English dictionary and are not common misspellings of English dictionary words. Once in the custom dictionary, adaptive TF-IDF program 126 uses the custom dictionary with these terms to identify future misspellings of these non-English dictionary words and then correct those misspellings. In some embodiments, adaptive TF-IDF program 126 automatically corrects a misspelled word or term. In other embodiments, adaptive TF-IDF program 126 enables manual correction of a misspelled word or term by a user through a user interface.

In step 230, adaptive TF-IDF program 126 scans each document in the corpus to identify subject matter relevant (SMR) words that appear in more than one document (but less than substantially all of the documents) to add to a list of SMR words, in which SMR words may include non-English dictionary words or terms. Essentially, the list of SMR words may include any word that is not on the list of stop words and was not identified as a misspelled word. In an embodiment, adaptive TF-IDF program 126 adds the identified subject matter relevant words to the list of SMR words as words are identified that meet the criteria of appearing in more than one document (but less than substantially all of the documents) and not being identified as a misspelled word. For example, if the subject matter of the corpus is cryptography, adaptive TF-IDF program 126 may identify the non-English dictionary term “DSG”, which is an acronym for “digital signature generation”, in more than one document in the corpus, and since the term is relevant to the subject matter of cryptography and is not just a misspelled word, adaptive TF-IDF program 126 adds “DSG” to the list of SMR words.

In step 240, adaptive TF-IDF program 126 assigns a TF multiplier to each identified subject matter relevant word in the list of SMR words based on a term frequency of the word, i.e., how many times the word appears in a document divided by a total number of words in the document. For example, adaptive TF-IDF program 126 identifies that the term “ICSF” occurs eight times in a document and the document has a total of 250 words, so adaptive TF-IDF program 126 calculates the term frequency (TF) to equal 8/250-0.032 and uses 0.032 as the TF multiplier for the term “ICSF” when completing the similarity assessment in the following step.

In step 250, adaptive TF-IDF program 126 performs a similarity assessment on the corpus using the list of stop words and list of unique words and associated TF multiplier weights for the unique words. In an embodiment, adaptive TF-IDF program 126 uses TF-IDF and cosine similarity for the similarity assessment on the corpus in which the list of stop words are ignored during the similarity assessment and the TF multiplier weights for the unique words are used to add greater weight to the unique words in the similarity assessment.

In some embodiments, upon a new document being added to the corpus, adaptive TF-IDF program 126 scans the new document to identify if there are any single occurrence or low occurrence words, any high occurrence words, or any SMR words that appear in the new document. If a single occurrence or low occurrence word that was already on the list of stop words is found in the new document and now the number of documents the low occurrence word appears in is not below the pre-set “low occurrence” threshold number of documents in the corpus, adaptive TF-IDF program 126 removes the single occurrence or low occurrence word from the list of stop words. If a SMR word that was already on the list of SMR words is found in the new document and with this new document the SMR word is now a high occurrence word, i.e., appearing in at least a pre-set threshold number of documents in the corpus, adaptive TF-IDF program 126 removes the SMR word from the list of SMR words and adds it to the list of stop words. If a high occurrence word is not found in the new document, adaptive TF-IDF program 126 determines whether with this new document if any of the high occurrence words in the list of stop words are now in less than the pre-set “high occurrence” threshold number of documents, and if so, removes the word from the list of stop words. In these embodiments, adaptive TF-IDF program 126 automatically updates the list of stop words and the list of SMR words (and associated TF multiplier weights) based on any identified stop words (or the lack of a stop word) and/or SMR words in the new document. In these embodiments, adaptive TF-IDF program 126 enables an updated similarity assessment to be run on the corpus using the updated list of stop words and the updated list of SMR words (and associated TF multiplier weights).

In some embodiments, after a predefined period of time has passed, adaptive TF-IDF program 126 determines whether any new documents have been added to the corpus. Responsive to adaptive TF-IDF program 126 determining that no new documents have been added to the corpus, adaptive TF-IDF program 126 waits the predefined period of time again. Responsive to adaptive TF-IDF program 126 determining that one or more new documents have been added to the corpus, adaptive TF-IDF program 126 scans the one or more new documents that have been added to the corpus to identify if there are any single occurrence or low occurrence words, any high occurrence words, or any SMR words that appear in the one or more new documents. If a single occurrence or low occurrence word that was already on the list of stop words is found in one or more of the one or more new documents and now the number of documents the low occurrence word appears in is not below the pre-set “low occurrence” threshold number of documents in the corpus, adaptive TF-IDF program 126 removes the single occurrence or low occurrence word from the list of stop words. If a SMR word that was already on the list of SMR words is found in one or more of the one or more new documents and now the SMR word is a high occurrence word, i.e., appears in at least a pre-set threshold number of documents in the corpus, adaptive TF-IDF program 126 removes the SMR word from the list of SMR words and adds it to the list of stop words. For each high occurrence word on the list of stop words, adaptive TF-IDF program 126 determines whether with the one or more new documents if the high occurrence word is now in less than the pre-set “high occurrence” threshold number of documents, and if so, removes the word from the list of stop words. In these embodiments, adaptive TF-IDF program 126 automatically updates the list of stop words and the list of SMR words (and associated TF multiplier weights) based on any identified stop words and/or SMR words in the one or more new documents. In these embodiments, adaptive TF-IDF program 126 enables an updated similarity assessment to be run on the corpus using the updated list of stop words and the updated list of SMR words (and associated TF multiplier weights).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A method comprising:
preprocessing, by one or more processors, a corpus of documents of a given subject matter in preparation for performing a similarity assessment on the corpus, wherein preprocessing comprises:
scanning, by the one or more processors, each document in the corpus to identify stop words, wherein a stop word is a high occurrence word that appears in at least a first pre-set threshold number of documents in the corpus or a low occurrence word that appears in less than a second pre-set threshold number of documents in the corpus;
adding, by the one or more processors, the stop words to a list of stop words;
performing, by the one or more processors, a spellcheck function on the corpus of documents, wherein the spellcheck function takes into consideration the given subject matter for determining whether a word is misspelled or is a unique term known in the given subject matter;
scanning, by the one or more processors, each document in the corpus to identify subject matter relevant words based on the given subject matter, wherein a subject matter relevant word is a word that is not on the list of stop words and is not identified by the spellcheck function as a misspelled word;
adding, by the one or more processors, the identified subject matter relevant words to a list of subject matter relevant words; and
assigning, by the one or more processors, a weight to each identified subject matter relevant word based on a term frequency, wherein the term frequency equals how many times a word appears in a respective document divided by a total number of words in the respective document;
performing, by the one or more processors, a similarity assessment on the corpus using the list of stop words and the list of subject matter relevant words with associated weights.

2. The method of claim 1, further comprising:
responsive to the spellcheck function identifying a low occurrence word of the low occurrence words is a misspelled word, automatically replacing, by the one or more processors, the misspelled word with a correctly spelled word in respective documents in the corpus.

3. The method of claim 1, further comprising:
responsive to the spellcheck function identifying a respective low occurrence word of the low occurrence words is not a misspelled word, automatically adding, by the one or more processors, the respective low occurrence word to a custom dictionary that can be used to identify and correct future misspellings of the low occurrence word.

4. The method of claim 1, wherein the spellcheck function determines whether each respective word matches within a preset spelling threshold or is a common misspelling of a known word of a main language of the corpus.

5. The method of claim 4, further comprising:
responsive to a respective word not matching within the preset spelling threshold and not being a common misspelling of a respective known word of the main language of the corpus, determining, by the one or more processors, whether the respective word is a known term of the given subject matter.

6. The method of claim 5, further comprising:
responsive to determining the respective word is the known term of the given subject matter, adding, by the one or more processors, the respective word to a custom dictionary that can be used to identify and correct future misspellings of the low occurrence word.

7. The method of claim 1, further comprising:
responsive to at least one new document being added to the corpus, updating, by the one or more processors, the list of stop words and the list of subject matter relevant words based on words in the at least one new document.

8. A computer program product comprising:
one or more computer readable storage media and program instructions collectively stored on the one or more computer readable storage media, the stored program instructions comprising:
program instructions to preprocess a corpus of documents of a given subject matter in preparation for performing a similarity assessment on the corpus, wherein the program instructions to preprocess comprise:
program instructions to scan each document in the corpus to identify stop words, wherein a stop word is a high occurrence word that appears in at least a first pre-set threshold number of documents in the corpus or a low occurrence word that appears in less than a second pre-set threshold number of documents in the corpus;
program instructions to add the stop words to a list of stop words;
program instructions to perform a spellcheck function on the corpus of documents, wherein the spellcheck function takes into consideration the given subject matter for determining whether a word is misspelled or is a unique term known in the given subject matter;
program instructions to scan each document in the corpus to identify subject matter relevant words based on the given subject matter, wherein a subject matter relevant word is a word that is not on the list of stop words and is not identified by the spellcheck function as a misspelled word;
program instructions to add the identified subject matter relevant words to a list of subject matter relevant words; and
program instructions to assign a weight to each identified subject matter relevant word based on a term frequency, wherein the term frequency equals how many times a word appears in a respective document divided by a total number of words in the respective document;
program instructions to perform a similarity assessment on the corpus using the list of stop words and the list of subject matter relevant words with associated weights.

9. The computer program product of claim 8, further comprising:
responsive to the spellcheck function identifying a low occurrence word of the low occurrence words is a misspelled word, program instructions to automatically replace the misspelled word with a correctly spelled word in respective documents in the corpus.

10. The computer program product of claim 8, further comprising:
responsive to the spellcheck function identifying a respective low occurrence word of the low occurrence words is not a misspelled word, program instructions to automatically add the respective low occurrence word to a custom dictionary that can be used to identify and correct future misspellings of the low occurrence word.

11. The computer program product of claim 8, wherein the spellcheck function determines whether each respective word matches within a preset spelling threshold or is a common misspelling of a known word of a main language of the corpus.

12. The computer program product of claim 11, further comprising:
responsive to a respective word not matching within the preset spelling threshold and not being a common misspelling of a respective known word of the main language of the corpus, program instructions to determine whether the respective word is a known term of the given subject matter.

13. The computer program product of claim 12, further comprising:
responsive to determining the respective word is the known term of the given subject matter, program instructions to add the respective word to a custom dictionary that can be used to identify and correct future misspellings of the low occurrence word.

14. The computer program product of claim 8, further comprising:
responsive to at least one new document being added to the corpus, program instructions to update the list of stop words and the list of subject matter relevant words based on words in the at least one new document.

15. A computer system comprising:
one or more computer processors;
one or more computer readable storage media;
program instructions collectively stored on the one or more computer readable storage media for execution by at least one of the one or more computer processors, the stored program instructions comprising:
program instructions to preprocess a corpus of documents of a given subject matter in preparation for performing a similarity assessment on the corpus, wherein the program instructions to preprocess comprise:
program instructions to scan each document in the corpus to identify stop words, wherein a stop word is a high occurrence word that appears in at least a first pre-set threshold number of documents in the corpus or a low occurrence word that appears in less than a second pre-set threshold number of documents in the corpus;
program instructions to add the stop words to a list of stop words;
program instructions to perform a spellcheck function on the corpus of documents, wherein the spellcheck function takes into consideration the given subject matter for determining whether a word is misspelled or is a unique term known in the given subject matter;
program instructions to scan each document in the corpus to identify subject matter relevant words based on the given subject matter, wherein a subject matter relevant word is a word that is not on the list of stop words and is not identified by the spellcheck function as a misspelled word;
program instructions to add the identified subject matter relevant words to a list of subject matter relevant words; and
program instructions to assign a weight to each identified subject matter relevant word based on a term frequency, wherein the term frequency equals how many times a word appears in a respective document divided by a total number of words in the respective document;
program instructions to perform a similarity assessment on the corpus using the list of stop words and the list of subject matter relevant words with associated weights.

16. The computer system of claim 15, further comprising:
responsive to the spellcheck function identifying a low occurrence word of the low occurrence words is a misspelled word, program instructions to automatically replace the misspelled word with a correctly spelled word in respective documents in the corpus.

17. The computer system of claim 15, further comprising:
responsive to the spellcheck function identifying a respective low occurrence word of the low occurrence words is not a misspelled word, program instructions to automatically add the respective low occurrence word to a custom dictionary that can be used to identify and correct future misspellings of the low occurrence word.

18. The computer system of claim 15, wherein the spellcheck function determines whether each respective word matches within a preset spelling threshold or is a common misspelling of a known word of a main language of the corpus.

19. The computer system of claim 18, further comprising:
responsive to a respective word not matching within the preset spelling threshold and not being a common misspelling of a respective known word of the main language of the corpus, program instructions to determine whether the respective word is a known term of the given subject matter.

20. The computer system of claim 19, further comprising:
responsive to determining the respective word is the known term of the given subject matter, program instructions to add the respective word to a custom dictionary that can be used to identify and correct future misspellings of the low occurrence word.
